(19) United States
(12) Patent Application Publication
(10) Pub. No.: US 2010/0162208 A1
(43) Pub. Date: Jun. 24, 2010

(54) MODELING TOOL BUILDER - GRAPHICAL EDITOR CONSTRUCTION

(75) Inventors: David Amid, Kiryat Ata (IL); Ateret Anaby-Tavor, Givat Ada (IL); Amit Fisher, Nofit (IL); Aviad Sela, Yokneam (IL); Gal Shachor, Yokneam (IL); Vadim Vasilov, Haifa (IL)

Correspondence Address: SCULLY, SCOTT, MURPHY & PRESSER, P.C., 400 GARDEN CITY PLAZA, SUITE 300, GARDEN CITY, NY, 11530, US

(73) Assignee: International Business Machines Corporation, Armonk, NY (US)

(21) Appl. No.: 12/339,403

(22) Filed: Dec. 19, 2008

(51) Int. Cl. G06F 9/44

(52) U.S. Cl. 717/107

(57) ABSTRACT

A modeling tool may be created directed from a drawing. A plurality of components and their relationships are deduced from the drawing and defined as a metamodel. One or more user operations performed while creating the drawing are also determined and used in building the metamodel. The metamodel may be used in a fixed mode to create a model with definition of the metamodel. The metamodel may be also used in a flexible mode to further redefine the metamodel or create a second metamodel.

### CROSS-REFERENCE TO RELATED APPLICATIONS

This application is related to U.S. patent application Ser. No. ______ entitled, “A METHOD AND SYSTEM FOR IDENTIFYING GRAPHICAL MODEL SEMANTICS,” (attorney docket IL920080070US1 (22658)), filed on Dec. 19, 2008 and assigned to the same assignee in the present application, contents of which are incorporated by reference herein in their entirety.

### FIELD OF THE INVENTION

The present disclosure is related to modeling tools, and more particularly to a modeling tool builder.

### BACKGROUND OF THE INVENTION

Building a modeling tool today requires significant amount of work and programming developing skills. The present disclosure is directed to a modeling tool builder that simplifies creating a desired modeling tool. For example currently if a user wants to build a modeling tool may it be a Business Process Modeling Notation (BPMN) model, a Use Case (UC) model or a Component Business Modeling (CBM) model, the user needs to seek for a proprietary tool that can be used in order to create the specific model with all its semantic meanings and inner relations. If there is not one that fits the user's needs, the user must resort to using a freehand drawing tool with no or loose semantics.

U.S. Pat. No. 7,240,327 discloses creating a meta-data for a modeling tool from the instance information for pre-defined object types input in a GUI. “MetaBuilder: the diagrammer's diagrammer” by R. I. Ferguson and A. Hunter discloses generating a meta model by drawing items in a specific notation. The meta model is further used for automatically generating a target tool. The notation is based upon the concept of a mathematical graph consisting of nodes and edges.

U.S. Pat. No. 7,096,454 discloses a method for creating models using gestures drawn by user. The gesture is interpreted based on a meta-model and an algorithm creates or modifies model elements based on the interpretations. WO06106495A1 discloses generating a meta model from a data model by extracting meta data from an existing data model. U.S. Patent Application Publication 2005/0160401A1 discloses customizing a modeling tool according to user's needs. U.S. Pat. No. 7,000,219 discloses developing a software system using a metamodel.

“Using meta-modelling and graph grammars to create modelling environments” by De Lara Jaramillo, Juan; Vangheluwe, Hans; and Moreno, Manuel Alfonseca discloses combined use of meta-modelling and graph grammars for the generation of visual modelling tools for simulation formalisms.

### BRIEF SUMMARY OF THE INVENTION

A system and method for building a modeling tool are provided. The method in one aspect may comprise configuring a modeling tool. The step of configuring may further comprise at least defining a meta model and specifying building blocks and semantics for the meta model. The method may also include generating a modeling tool using the defined meta model, and executing the modeling tool in flexible mode in which the semantics of the meta model is overridden in creating a model using the meta model, or in a strict mode in which the semantics of the meta model are strictly enforced. If one or more definitions in the semantics of the meta model is overridden with one or more new definitions, the method may also include allowing redefining of the meta model based on said one or more new definitions.

A method for building a modeling tool, in another aspect, may comprise determining a plurality of components in a drawing, and defining the plurality of components as plurality model components, respectfully. The method may also include determining one or more relationships between the plurality of components in the drawing; and

defining said one or more relationships between the plurality of components as one or more model component relationships. The plurality of model components and said one or more model component relationships form a metamodel of the drawing.

A system for building a modeling tool, in one aspect, may comprise a configuration module operable to configure a modeling tool. The configuration module may be further operable to at least define a meta model and specify building blocks and semantics for the meta model. A modeling tool generator module is operable to generate the modeling tool based on the defined meta model and specified building blocks and semantics. The generated modeling tool is operable to execute in flexible mode in which the semantics of the meta model is overridden in creating a model using the meta model, or in a strict mode in which the semantics of the meta model are strictly enforced. If one or more definitions in the semantics of the meta model is overridden with one or more new definitions, the generated modeling tool may be operable to allow redefining of the meta model based on said one or more new definitions.

A system for building a modeling tool, in another aspect, may comprise a first module operable to determine a plurality of components in a drawing and one or more relationships between the plurality of components in the drawing. The first module may be further operable to determine one or more user operations performed while creating the drawing. A second module is operable to define the plurality of components as plurality model components, respectfully, and said one or more relationships between the plurality of components as one or more model component relationships. A model creator module is operable to generate a metamodel using the plurality of model components, said one or more model component relationships and said one or more user actions.

A program storage device readable by a machine, tangibly embodying a program of instructions executable by the machine to perform methods of building a modeling tool may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a target diagram drawn from which a metamodel may be deduced.

FIG. 2 illustrates a process diagram of the stages for a modeling tool builder in one embodiment of the present disclosure.

FIG. 3 illustrates detail steps of the first stage shown in FIG. 1.

FIG. 4 shows a Component Business Map example.

FIG. 5 shows the deduced metamodel from the FIG. 4.

FIG. 6 illustrates a general form of the deduced metamodel.

FIG. 7 illustrates a computer system and processor that may implement the system and method of the present disclosure.

### DETAILED DESCRIPTION

A modeling tool builder enables business users to invent their own models and design a modeling tool accordingly It provides business users with the ability to use generated model editors. In one aspect, the modeling tool builder of the present disclosure may simplify the creation of a desired modeling tool, thus allowing a business user even without a developer capability to build a model. The modeling tool builder of the present disclosure takes the data such as the shapes, properties, relationships and semantics as inputs. Using those input specifications, the tool is capable of generating a modeling editor ready for use. Using the tool of the present disclosure, the user could design the modeling editor and customize it to the user's needs.

The modeling tool of the present disclosure in one embodiment is adaptable or adjustable to individual modeling needs. For instance, a business modeler who aspires to create a CBM editor will find a modeling tool builder that aims it towards a static containment based relationship editor while a BPMN editor creator will be prompted with a dynamic connectable elements editor.

In one embodiment, the modeling tool of the present disclosure is supported by a meta-meta-model which encompasses a superset of a variety of meta-models. The categorization of the different meta models supported by this meta-meta-model enables the shifting of the usability towards the intended product.

The modeling tool builder of the present disclosure in one embodiment may generate any type of model, whether workflow, enterprise architecture, strategic, or domain specific. In the “designing phase” user can work in two modes: either explicitly create visual meta-models as well as semantics, constraints, and their meanings or provide an instance model for the tool from which to infer structure and semantics. When working in the former mode the modeling tool builder may offer pin-point usability experience, narrowing down options and features to exactly what the user needs at any given time; and enable the definition of relationships and constraints between meta-models and elements. This mode utilizes the “Metamodel Visualizer” tool of the modeling tool builder. The metamodel visualizer is a tool that enables a user to define a metamodel by specifying meta meta elements, semantics and rules, etc. Instead of specifying these attributes in a textual manner the metamodel visualizer enables the specification of the meta model building blocks and semantics in a graphical manner. Hereafter a detailed description of the graphical manner is described. An example for a Metamodel Visualizer which has some graphical capabilities is the CaseMaker product provided by QualiWare (http://www2.qualiware.com/Document/81ec50b5-b762-442a-afe9-a44d2eaff577.htm).

Users may define the models and specify their element's shape, properties, and semantics without being limited to a few predefined models allowed by existing tools. The modeling tool builder of the present disclosure turns these model definitions into a model, automatically generating a suitable modeling tool. The model tool builder of the present disclosure may be less error-prone than a conventional drawing tool, resulting in increased rate of investment (ROI).

Briefly, an element is a figure in the model, a meta element is a figure in the meta model and a meta-meta element is a figure in the meta-meta-model. The Metamodel Visualizer enables the user to choose the appropriate meta-meta elements, and thus reduces the complexity of building the meta model. User is also enabled to specify a metamodel in a non-conventional graphical fashion. That is, the user may use drawing to explicitly define the metamodel, in contrast to specifying it in a form based solution. Therefore, when designing the metamodel the user continually works with a shape gallery that can be populated as needed, and graphical notations that will be interpreted by the system of the present disclosure and correlated to the right features of the metamodel. In the same manner, the user may also design each model element appearance in the graphical model. For example, if a round rectangle is meant to be a container in the metamodel, after selecting it from the shape gallery and classifying it as a container, the user may put elements (i.e., other shapes) in it, implying to the system the elements this rectangle aggregates; the user may also define these inner element locations within the container, and by that action the user specifies the element appearance in the model representation (e.g., may the location be free in the rectangle area or do certain elements appear in certain places like the footer of the rectangle?). Moreover the user can even specify the multiplicity of the relationship between the container and each of its aggregated types by using predefined graphical notations in the drawing (e.g., overlapping shapes).

The system of the present disclosure in one embodiment offers pin-point usability experience, narrowing down options and features to exactly what the user needs at any given time. Thus, if the user chooses to define the metamodel using the Metamodel Visualizer, the system of the present disclosure still enables the user to work in a less complex manner by directly pinpointing to the meta element type. For example, the set of meta-meta elements may be {container, edge, node}, however, the user may want to create a model that is comprised of nodes and containers as meta-elements and no edges at all (such a model may be in the form of a table). Therefore, the Metamodel Visualizer would a priori direct the user only to the input screens of nodes and containers, eliminating possibilities that are out of scope.

In its second mode, (referred herein as the “Instance Based Learning”) the modeling tool builder (“MTB”) may allow users to draw their models, and therefore, users need not be asked to explicitly describe the meta model. The MTB then deduces a meta model out of the model the user has drawn. For that purpose the MTB derives the building blocks of the model as well as the semantic representation. For example, if the user draws an instance (i.e., a model) with 3 elements: element1, element2, element3 and then a link between element1 and element2, but does not connect element1 to element3, the MTB may deduce that element1, element2 and element3 are instances of three different metamodel “types” (note that the initial setting could be different). Consequently it may deduce that any model element of type similar to that of “element1” (e.g., elements of type “type1”) should not be allowed to connect to elements that are of type similar to that of “element3” (e.g., elements of type “type3”). As another example, if the user drops element4 into element3, the MTB may deduce that elements of type similar to that of “element3” (“type3”) are containers that can have parent-child relationships with elements of type similar to that of “element4” (“type4”).

The MTB may also evolve or generate the meta model along with the model being developed as the user draws or develops the model. At anytime during the development the user can “take a snapshot” and catalog the meta model for further usage. This way the user could generate a specialized tool at any stage of model development and even develop the meta model in phases. This specialized tool will support the “gallery of types” and the semantics for the purpose of creating instances of the same metamodel. For example, continuing with the above-described example, the specialized tool that will be created comprises a UI feature that presents building blocks of type type1, type2, type3 and type4 and a semantic feature that is responsible for policies such as “type1 may not be allowed to connect to type3”. After a while the user may decide that on some occasions there should actually be a connection between elements of type similar of that of “element1” to elements of type similar to that of “element3”. The user at that point may add such a scenario to the model (e.g., by using the “Metamodel Visualizer” or the “Instance Based Learning”), and the MTB will add the scenario to the meta model. Thus, the metamodel that was deduced without knowing that element1 can be connected to element3 will be iteratively authored during the work of the user on the instance at hand.

Another applicability of the “Instance Based Learning” functionality might be the derivation of a meta model from a given model which was modeled in any other drawing tool, thus enabling the user to migrate from a drawing tool which has no semantics to a specialized graphical modeling tool.

A method and system of the present disclosure allows for creating or generating a meta modeling tool from any drawing without constraining the drawing. The user defines the modeling tool by either drawing instances of a model (via “Instance Based Learning” functionality) or specifically drawing the metamodel in a graphical wizard based fashion, for instance, using a tool such as the “Metamodel Visualizer”. The user can iterate any number of times between the two different options. Each iteration to the instance enriches the metamodel and hence its visualization. The method and system of the present disclosure, in one aspect, may automatically create a metamodel representation from instances drawn by the user. The method and system do not constrain the drawn instance.

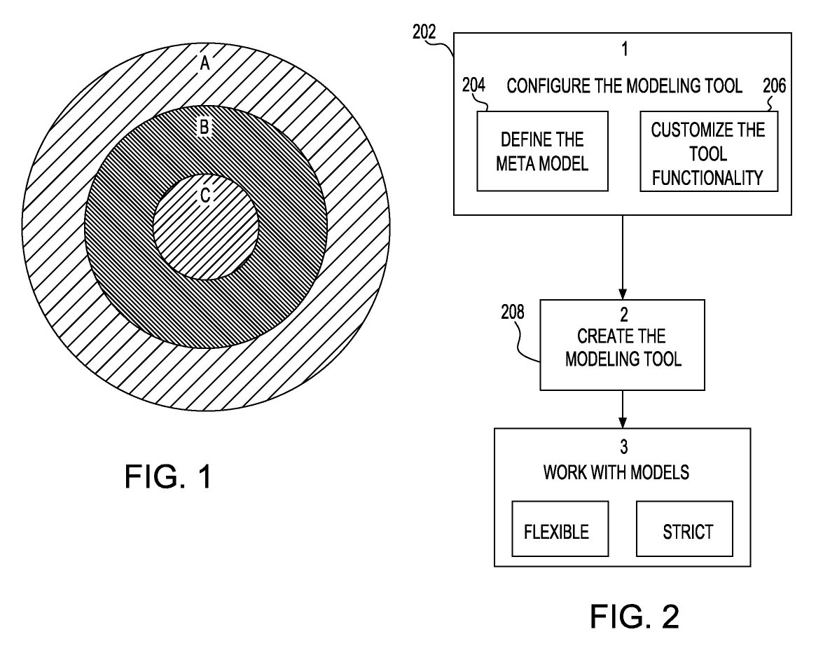

When working in the “Instance Based Learning” mode, the system and method of the present disclosure may learn from drawing manner (e.g., user actions), the drawing, and one or more notations in the drawing. In some diagrams, the metamodel can be deduced more accurately if the sequence of operations performed by the user is also examined. FIG. 1, for instance, represents a target diagram. Although it shows three nested circles, an error might occur in deducing that there are only two elements rather than three, for instance, if elements B and C were read as being one element. This type of errors would not occur, if the system knows that the user built the diagram from three circles and inserted them into one another. Even if the error occurs first from the drawings, the error may be corrected by verifying the user actions.

Similarly, notations in the drawings describe many parameters such as colors, text, figures and more. Each parameter might have different influence or weight on the identification of a drawing as a metamodel element. This influence is calculated according to different parameters as well, for example, cognitive importance (e.g., figure is a better identification than color) and multiplicity (e.g., many different figures with few colors might indicate that the color is the unique identifier).

To enable the user to verify the inferred semantics and structure the MTB may use a “representative instance”. During the modeling tool definition phase the user can generate an instance (or set of instances) which will reflect all the semantics included in the metamodel (that semantics was obtained by working either in the “Metamodel Visualizer” mode or the “Instance Based Learning” mode). The user will use the representative instance to feedback the system on its accomplishments. This representative instance aims to represent a set of cases that the metamodel enables. The representative instance is built by applying configurable rules on the deduced metamodel. For example, a rule may treat all figures of type link as links with “many to many” relationship unless explicitly specified otherwise. Furthermore, when editing the representative instance the system will update the metamodel with constraints learned from the changes the user has made to that instance. The user can either confirm or reject the inferred semantics and structure by examining the representative instance. These user actions on the representative instance reduce the need for negative examples since the undesired metamodel characteristics can be deduced implicitly. At any time the user can decide to generate a modeling tool which will support the suggested metamodel. Working with the generated tool may be done in the “runtime phase”. The generated tool can operate in two modes: flexible and strict. When operating in a strict mode the tool is similar to the conventional modeling tool which enforces the semantic of the underlying metamodel. Operating in the flexible mode the tool allows the user to model any kind of model including one that violates the semantics of the metamodel. Any violation is promptly notified to the user and recorded by the tool. The user can then iterate back to the “definition phase” and update the metamodel. The iteration back to the definition phase is done according to the nature of the user change e.g., if the user removes elements from the model then they are referred to the “Metamodel Visualization” mode, and if the user want to add elements or relations then the “Instance Based Learning” is suggested.

Defining a modeling tool includes a metamodel definition and the tool functionality. The method and system of the present disclosure in one embodiment provide the user with both the ability to use a predefined tool definition, customize the tool definition by adding and\or removing functionalities, and importing new functionalities which will be incorporated in the generated tool. The system of the present disclosure will generate the code related to the metamodel and assemble it as a compartment in a full functional modeling editor (the system may provide a basic graphical user interface that is customizable).

In one embodiment of the present disclosure, the system and method automatically create a metamodel representation from instances drawn by the user. The method does not constrain the drawn instance. The method learns from both the drawing manner and the drawing itself, and the notation. The notation identifies metamodel constructs. The system and method also may create a representative instance from the metamodel which enables the user to: edit the generated instance which reflects all the metamodel definitions and submit it as an example; and learn from the changes to the representative instance on constraints. Hybrid creations may be enabled with the above-described capabilities. The modeling tool implemented according to the system and method of the present disclosure may operate in a flexible mode where all semantic violations are recorded and updated in the metamodel.

FIG. 2 illustrates a process diagram of the stages for a modeling tool builder in one embodiment of the present disclosure. At the first stage 202, the modeling tool is being configured. In this configuration stage, the tool is being designed to work with the specific model at hand. This stage may include two parallel phases: defining the model building blocks and semantics (i.e, the metamodel) 204 and customizing functionalities of the modeling tool to be generated 206. The customization of the modeling tool functionalities is an optional stage that may include modifications to the toolbar, palette, properties and other views of the tool according to user preferences. The second stage 208 illustrates the generation of the modeling tool which adheres to the definitions specified in stage 1. The third stage 210 represents the modeling experience itself which enables the user to work with the generated tool and produce new instances of that model type. In this stage the user can use a flexible modeling approach which provides variability, e.g., the capability of overriding the semantics enforced by the metamodel. The user can select to operate in strict mode in which the generated meta model definition is strictly enforced.

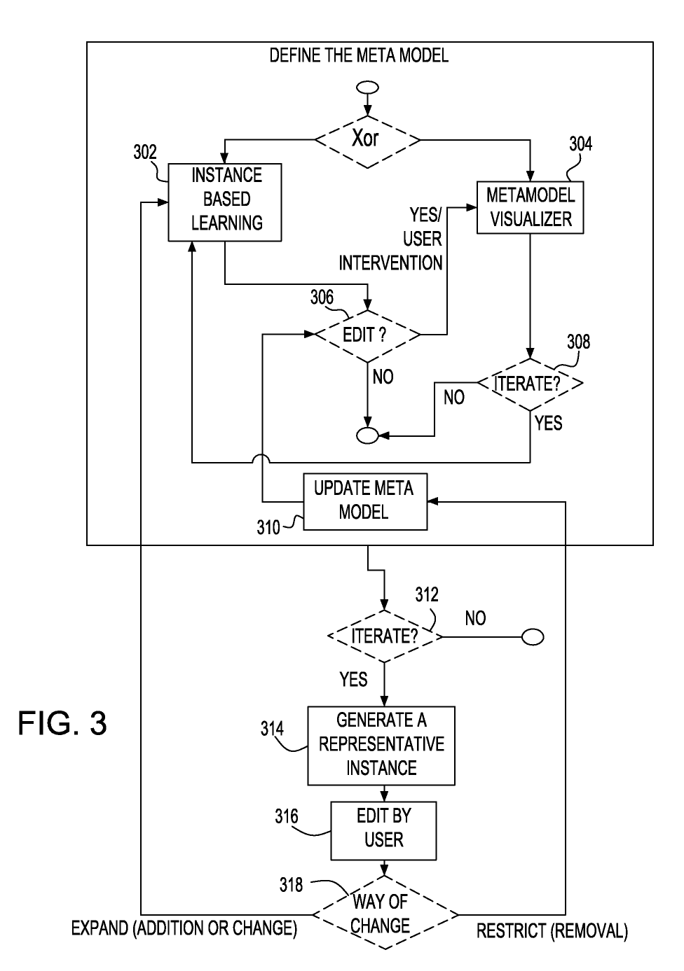

FIG. 3 illustrates detail steps of configuring meta model stage 204 shown in FIG. 2. In this stage, the user can choose how to “teach” the system the model type. Choices may include the Instance Based Learning choice 302 (where user draws a model and the tool deduces the metamodel accordingly), or the Metamodel Visualizer 304 (where the user draws the metamodel explicitly). The user may work with the Metamodel Visualizer on top of the meta model that was deduced by the Instance Based Learning, i.e., the user may draw a model and allow the tool to build a metamodel by deducing from the drawing, and also use a metamodel visualizer to additionally and explicitly specify a metamodel definition (shown at steps 306 and 310).

At 312, the system and method of the present disclosure allow the user to change the semantic that was already recorded for the model. That can be done through inputs that the user enters to a representative instance of the deduced metamodel at 314. This instance aims to represent a set of cases that the metamodel enables. The representative instance is built by applying configurable rules on the deduced metamodel. At 316, the user edits the representative instance to suit constraints, policies, and/or model elements yet unknown to the tool. The iteration back to either “Instance Based Learning” or “Metamodel Visualizer” is done according to the change characteristics at 318. Consequently if the user adds an element or relaxes a restriction the tool may use the “Instance Based Learning”, while removal of types from the metamodel may require intervention via the Metamodel Visualizer. For example, if the user wants to record that elements of type “type1” can now also be connected to elements of type “type3”, they may draw such a connection in the representative instance and the “Instance Based Learning” mechanism at 302 will update the metamodel accordingly. On the other hand, if all elements of type1 should be eliminated from the metamodel the “Metamodel Visualizer” at 304 will be selected.

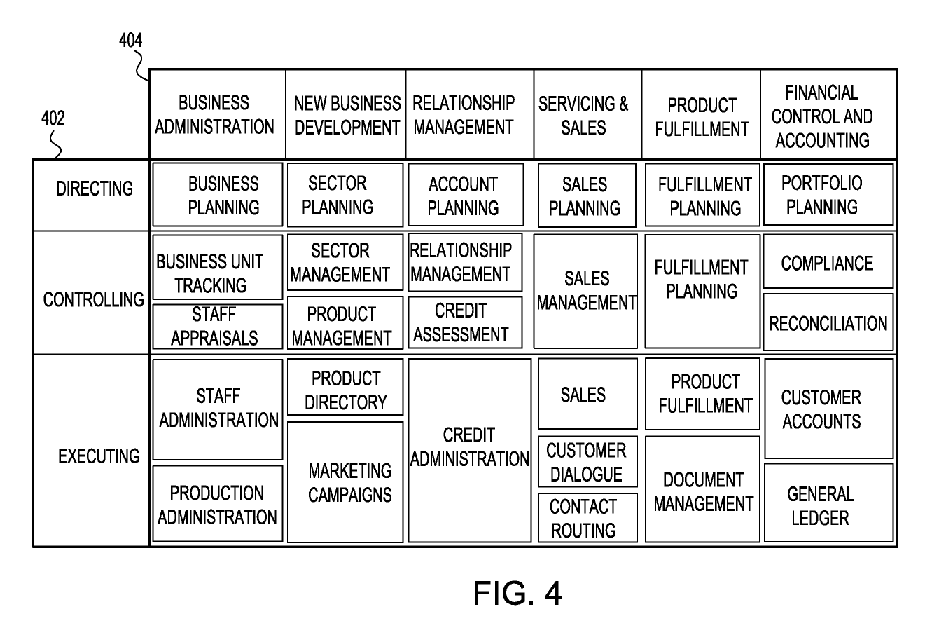

An example of the learning from a diagram drawn by the user is described herein. FIG. 4 shows a CBM (Component Business Map) example. The model generated is made up from a grid that is composed of 3 accountability levels 402 and any number of competencies (business domains) 404. The user then placed business components within that grid. In one embodiment, the method of the present disclosure learns a metamodel using the following approach:
1. Deduce a column object which contains four rows, where the first one is unique due to its color. (Note that the tool sees 4 rows and not three, the first one is the title row and may be recognized as such due to its different color).
2. Deduce a table object which contains many columns where the left most one is unique due to its color.
3. Deduce a component object which is contained in a predetermined row. Also deduce that a component is an atomic element (i.e., no object is contained in a component object). Each component has different (e.g., free) text in it.

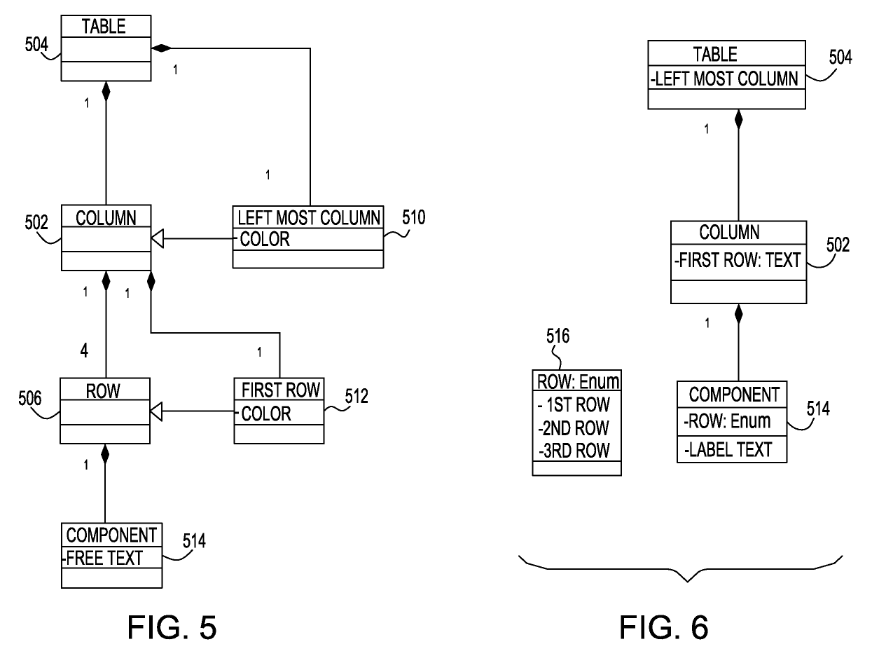

FIG. 5 shows the deduced metamodel from the FIG. 4 example. Column object 502 has many to one relationship with the table object 504. Row object 506 has 4 to 1 relationship with the column object 502 (the 4 rows stand for 3 accountability levels and a title). Each row object 506 may include many component objects 508. Left most column object has one to one relationship with the table object 504, and is related to the column object 502 with ‘Is A’ (inheritance) relationship, where its unique characteristic over its superclass ‘Column’ is its color. First row object 512 has one to one relationships with the column object 502, and is related to the row object 506 with ‘Is A’ (inheritance) relationship, where its unique characteristic over its superclass ‘Row’ is its color. Component object 514 has many to one relationship with the row object 506 and contains free text.

General rules may be applied over this metamodel to build a condensed form as shown in FIG. 6. The condensed form may be needed for a better metamodel representation for example in XML (extensible markup language) schema definition (XSD) or ecore techniques. The derivation of the condensed form may be done by applying general rules such as: “If a class A inherits from class B and both classes have composite relationship with class C, and the relationship of class C with class A have multiplicity of 1:1 then we can derive the condense form which is; eliminate class A and the association of class A to class C and transform class A to an attribute of class B”. Condensed metamodel definition includes the table object 504, column object 502, component object 514 and row enum object 516.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “Module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

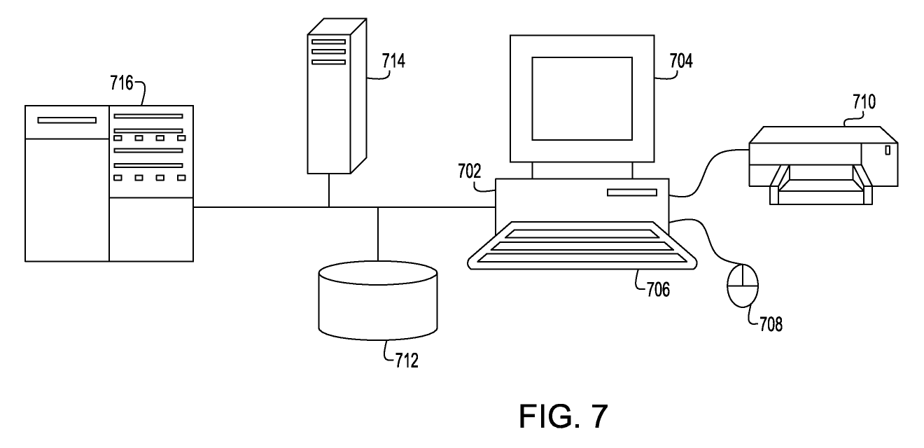

Referring now to FIG. 7, the systems and methodologies of the present disclosure may be carried out or executed in a computer system that includes a processing unit 720, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit 720 by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen 704 for presenting output displays and providing a display through which the user may input data and interact with the processing system, for instance, in cooperation with input devices such as the keyboard 706 and mouse device 708 or pointing device. The computer processing system may be also connected or coupled to one or more peripheral devices such as the printer 710, scanner (not shown), speaker, and any other devices, directly or via remote connections. The computer processing system may be connected or coupled to one or more other processing systems such as a server 710, other remote computer processing system 714, network storage devices 712, and/or other devices via any one or more of a local Ethernet, WAN connection, Internet, etc. or via any other networking methodologies that connect different computing systems and allow them to communicate. The various functionalities and modules of the systems and methods of the present disclosure may be implemented or carried out distributedly on different processing systems (e.g., 702, 714, 718), or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer-implemented method for building a modeling tool, comprising:
determining a plurality of components in a drawing;
defining the plurality of components as plurality model components, respectfully;
determining one or more relationships between the plurality of components in the drawing; and
defining said one or more relationships between the plurality of components as one or more model component relationships, said plurality of model components and said one or more model component relationships forming a metamodel of the drawing.

2. The method of claim 1, further including:
deducing semantics rules for the metamodel based on said one or more relationships.

3. The method of claim 1, further including:
said determining and defining steps are performed dynamically as the drawing is being drawn.

4. The method of claim 1, further including:
determining one or more user operations performed while creating the drawing; and
using said one or more user operations to determine the plurality of components and said one or more relationships between the plurality of components in the drawing.

5. The method of claim 1, wherein the drawing is created using a computer tool unrelated to the metamodel.

6. The method of claim 1, wherein the plurality of components and said one or more relationships between the plurality of components are determined using visual cues in the drawing.

7. The method of claim 1, further including:
using the metamodel to further build a second metamodel.

8. The method of claim 1, wherein the metamodel is used in a fixed mode for creating a model of the metamodel.

9. The method of claim 1, wherein the metamodel is used in a flexible mode for further redefining the metamodel.

10. The method of claim 9, further including allowing a user to create a model using the metamodel, and allowing one or more model definition violations to be committed when using the metamodel.

11. The method of claim 10, wherein said model definition violations are reported to the user and used to redefine the metamodel.

12. A system for building a modeling tool, comprising:
a processor;
a first module operable to determine a plurality of components in a drawing and one or more relationships between the plurality of components in the drawing, said first module further operable to determine one or more user operations performed while creating the drawing; and
a second module operable to define the plurality of components as a plurality model components, respectfully, and said one or more relationships between the plurality of components as one or more model component relationships,
a model creator module operable to generate a metamodel using said plurality of model components, said one or more model component relationships and said one or more user actions.

13. The system of claim 12, further including:
a visualizer tool operable to allow a user to further refine the generated metamodel.

14. A method of building a modeling tool, comprising:
configuring a modeling tool, the step of configuring further comprising at least defining a meta model and specifying building blocks and semantics for the meta model;
generating a modeling tool using the defined meta model;
executing the modeling tool in flexible mode in which the semantics of the meta model is overridden in creating a model using the meta model, or in a strict mode in which the semantics of the meta model are strictly enforced; and
if one or more definitions in the semantics of the meta model is overridden with one or more new definitions, allowing redefining of the meta model based on said one or more new definitions.

15. The method of claim 14, wherein the step of configuring further includes customizing one or more functionalities that operates with the meta model.

16. The method of claim 15, wherein step of customizing said one or more functionalities include customizing functionalities including at least tool bar, palette, properties and views in accordance with a user preference.

17. The method of claim 14, wherein the step of executing the modeling tool includes executing the modeling tool in flexible mode in which the semantics of the meta model is overridden in creating a model using the meta model.

18. The method of claim 14, wherein the step of defining a meta model further includes learning from an instance of a drawing and using formally specified definitions or combinations thereof.

19. The method of claim 14, wherein the step of defining a meta model further includes learning from an instance of a drawing and the step of learning from an instance of a drawing includes:
determining one or more components in the drawing;
determining one or more relationships between said one more components in the drawing; and
deducing one or more building blocks and semantics for the meta model from said determined one or more components and said determined one or more relationships.

20. The method of claim 19, further including:
said steps of determining one or more components and one or more relationships are performed dynamically as the drawing is being drawn.

21. The method of claim 19, further including:
determining one or more user operations performed while creating the drawing; and
using said one or more user operations to determine said one or more components and said one or more relationships.

22. A system for building a modeling tool, comprising:
a computer-implemented configuration module operable to configure a modeling tool, the configuration module further operable to at least define a meta model and specify building blocks and semantics for the meta model; and
a computer-implemented modeling tool generator module operable to generate the modeling tool based on the defined meta model and specified building blocks and semantics, said generated modeling tool operable to execute in flexible mode in which the semantics of the meta model is overridden in creating a model using the meta model, or in a strict mode in which the semantics of the meta model are strictly enforced, and if one or more definitions in the semantics of the meta model is overridden with one or more new definitions, the generated modeling tool further operable to allow redefining of the meta model based on said one or more new definitions.

23. The system of claim 22, wherein the configuration module is further operable to customize one or more functionalities that operates with the meta model.

24. The system of claim 23, wherein the configuration module is further operable to customize said one or more functionalities including at least customizing tool bar, palette, properties and views in accordance with a user preference.

25. A program storage device readable by a machine, tangibly embodying a program of instructions executable by the machine to perform a method of building a modeling tool, comprising:
configuring a modeling tool, the step of configuring further comprising at least defining a meta model and specifying building blocks and semantics for the meta model;
generating a modeling tool using the defined meta model;
executing the modeling tool in flexible mode in which the semantics of the meta model is overridden in creating a model using the meta model, or in a strict mode in which the semantics of the meta model are strictly enforced; and
if one or more definitions in the semantics of the meta model is overridden with one or more new definitions, allowing redefining of the meta model based on said one or more new definitions.
